(19) United States
(12) Patent Application Publication
(10) Pub. No.: US 2005/0201108 A1
(43) Pub. Date: Sep. 15, 2005

(54) Weather resistant lighting fixture

(75) Inventors: Harold J. Brown, Poultney, VT (US); George B. Chandler, Castleton, VT (US)

Correspondence Address: Liniak, Berenato & White, Ste. 240, 6550 Rock Spring Drive, Bethesda, MD, 20817, US

(73) Assignee: HUBBARDTON FORGE

(21) Appl. No.: 10/798,463

(22) Filed: Mar. 12, 2004

(51) Int. Cl. F21V 15/00

(52) U.S. Cl. 362/382

(57) ABSTRACT

A weather-resistant lighting fixture primarily designed for use in outdoor environments. The fixture is comprised of a lighting device attached to a bracket assembly and at least partially enclosed by a light shelter. In the preferred embodiment, the bracket assembly includes a base plate and a channel bracket that extends outward from the base plate. The light shelter has a retaining lip designed to engage the bracket to create a substantially watertight seal. In the preferred embodiment, the lighting device is enclosed on the top and sides but remains open at the bottom to allow cooling air to circulate within the fixture.

### Background of the Invention

1. Field of the Invention

The invention generally relates to wall-mounted lighting fixtures. The invention more specifically applies to wall-mounted lighting fixtures used in outdoor environments, or in indoor environments that include splattering or falling moisture.

2. Description of the Background Art

Multiple decorative lighting fixture designs are readily available in most lighting and hardware stores. Outdoor light shelters come in a variety of styles and designs and may be comprised of glass, plastic, metal, or a combination of these or other materials. These shelters generally enclose the lighting fixture so that the fixture is protected from rain, snow and other forms of precipitation.

However, the decorative nature of many currently available light shelters results in designs that do not adequately protect the enclosed lighting device. While some of these shelters provide too little protection, other shelters completely enclose the lighting device so that there is insufficient cooling airflow, and as a result, the enclosed lighting device, such as a light bulb and socket, deteriorates and fails prematurely.

Some decorative shelters are riveted, welded, glued, or similarly permanently attached to their associated mounting structures. While this design has the advantage of simplicity, it does not allow the fixtures to be disassembled for repair or cleaning. This design also does not allow the shelter to be easily replaced without also replacing the mounting structure, which may require an electrician. Replaceable light shelters frequently include unnecessary and/or unreliable connecting hardware that may loosen over time, thereby exposing the fixture to moisture. The screws and clips that comprise these types of systems also rust, freeze in place, break, or bend, and specialized replacement parts are frequently not readily available. The connectors are also easily lost and require the use of additional tools to replace the light shelter or access the lighting element.

The need exists for a simple and reliable decorative light fixture that can be easily removed and replaced without tools or connecting hardware. The current invention provides an attractive light fixture that meets these criteria and adequately protects the lighting device from typical outdoor weather conditions, while at the same time providing sufficient airflow to cool a lighting device, such as a light bulb and socket, in a manner that does not degrade the life or lighting capability of the lighting device.

### SUMMARY OF THE INVENTION

The current invention is a weather-resistant lighting fixture primarily designed for use in outdoor environments. The fixture is comprised of a lighting device attached to a bracket assembly and at least partially enclosed by a light shelter. In the preferred embodiment, the bracket assembly includes a base plate and a channel bracket that extends outward from the base plate. The light shelter has a retaining lip designed to engage the bracket to create a substantially watertight seal. In the preferred embodiment, the lighting device is enclosed on the top and sides but remains open at the bottom to allow cooling air to circulate within the fixture.

### BRIEF DESCRIPTION OF THE DRAWINGS

The above and other objects, advantages, and novel features of the present invention will become apparent from the following detailed description of the invention illustrated in the accompanying drawings, wherein:

FIG. 1 is a perspective view of the invention with the light shelter removed.

FIG. 2 is a perspective view of the exposed exterior portion of the light shelter.

FIG. 3 is a perspective view of the connecting surfaces of light shelter.

FIG. 4 is a perspective view of an alternative embodiment of the bracket assembly.

FIG. 5 is a side view of the lighting fixture with the light shelter installed.

### DETAILED DESCRIPTION OF THE INVENTION

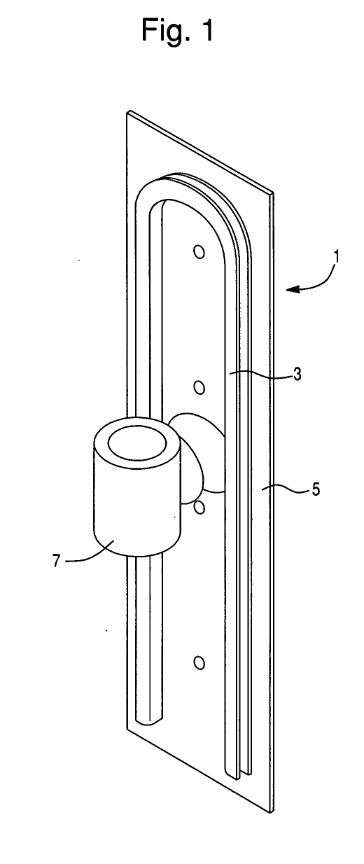

As best shown in FIG. 1, the present invention comprises a bracket assembly 1 adapted to be attached to a vertical wall. The bracket assembly 1 is comprised of at least a channel-type bracket 3, which may be directly attached to the wall. In the preferred embodiment, the bracket assembly 1 is also comprised of a base plate 5. The channel bracket 3 is attached to the base plate 5, and the base plate 5 is then attached to the wall. The base plate 5 may also be formed so that the channel bracket 3 is molded directly onto the surface of base plate 5, the channel bracket 3 and base plate 5 thereby forming a single unitary component.

The bracket assembly 1 may be attached to the wall with screws or by any other means known in the art. The bracket assembly 1 may be comprised of any type of material consistent with the function of the components, but is preferably comprised of a metal, such as aluminum. A lighting device 7 is attached to the wall through the bracket assembly 1. In the preferred embodiment the lighting device 7 is a light socket and light bulb, however, any means of illumination should be considered within the scope of the invention.

As best shown in FIG. 1, the lighting device 7 is at least partially encircled by the channel bracket 3. The channel bracket 3 extends horizontally outward from the wall and/or the base plate 5. In the preferred embodiment, the channel bracket 3 has a “U” shaped channel-type cross section. The channel bracket 3 is arranged on the wall/base plate 5 in an inverted “U” configuration. The channel bracket 3 extends vertically upward from below the lighting device 7 to a point above the lighting device 7 in an arcuate configuration, and then extends downward and terminates at a point below the lighting device 7.

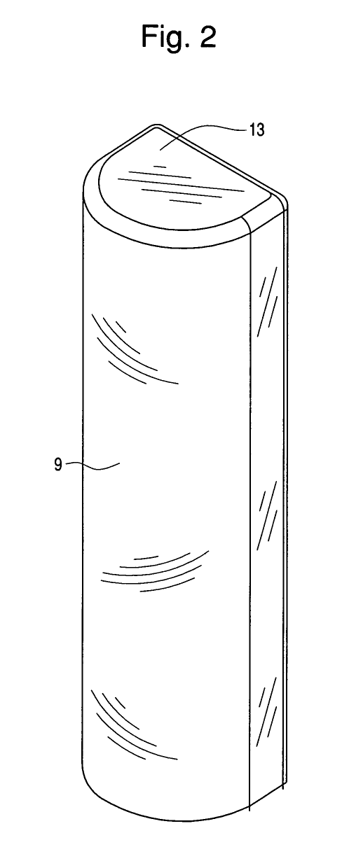

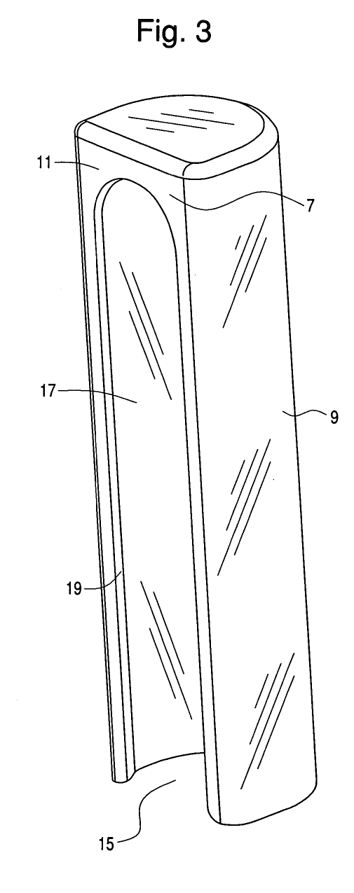

The channel bracket 3 is positioned on the wall and/or base plate 5 to receive a light shelter 9, as best shown in FIGS. 2 and 3. In the preferred embodiment, the light shelter 9 is flat on the side 11 that is designed to abut the wall and/or base plate 5, and rounded on the other three vertical sides, as best shown in FIG. 2. In the preferred embodiment, the top portion 13 of the light shelter 9 is also flat, and the bottom portion 15 of the light shelter 9 is open to allow cooling air to circulate around the lighting device 7, as best shown in FIG. 3.

As best shown in FIG. 3, the flat side 11 of the lighting shelter 9 includes an arcuate slot 17. The periphery of the slot 17 comprises a retaining lip 19 that is designed to engage the corresponding channel bracket 3 to form a secure and essentially watertight seal. The arcuate portion of the channel bracket 3 supports the weight of the lighting shelter 9. The lighting shelter 9 may be comprised of any material or combination of materials consistent with the description of the component. In the preferred embodiment, the lighting shelter 9 is comprised of glass or plastic.

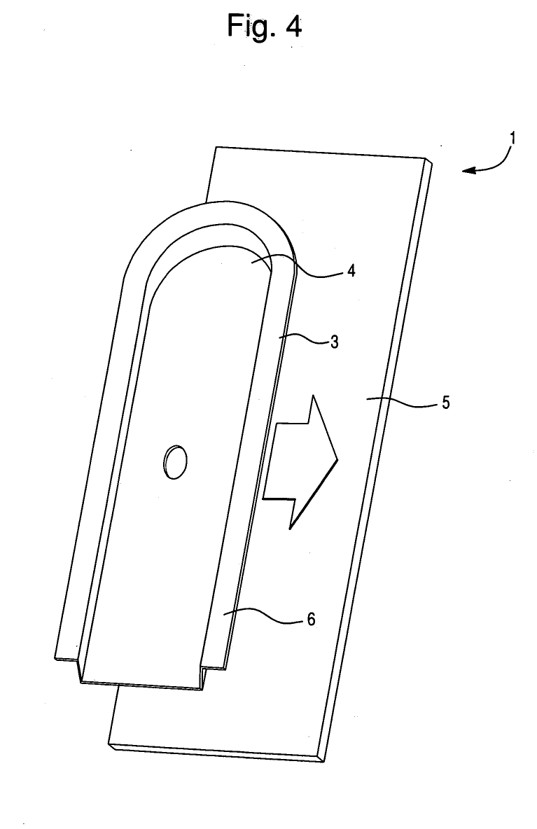

As best shown in FIG. 4, in an alternative embodiment, a bracket panel 4 forms the channel bracket 3. The bracket panel 4 is attached to the wall/base plate 5 so that a raised containment lip 6 of the bracket panel 4 forms a connecting surface that corresponds to the light shelter 9 retaining lip 19 when the light shelter 9 is installed on the bracket assembly 1. In the installed position, the alternative embodiment disclosed in FIG. 4 appears and functions substantially the same as the preferred embodiment configuration disclosed in FIG. 1.

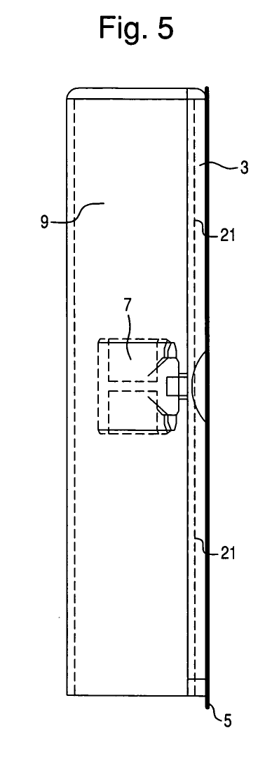

In operation, the light shelter 9 slides down onto the channel bracket 3 so that the lighting device 7 is enclosed on top and on the sides, but is open at the bottom, as best shown in FIG. 5. In the preferred embodiment, the light shelter 9 is supported vertically solely by the channel bracket 3, and is also horizontally secured to the wall/base plate 5 solely by the channel bracket 3. The watertight seal 21 between the bracket 3 and the light shelter 9 ensures that the lighting device 7 will remain dry when the fixture is subjected to precipitation. The snug fit between the channel bracket 3 and the light shelter 9 retaining lip 19 also ensures the substantially watertight seal 21. Additionally, water is directed away from the lighting device 7 by the “U” shaped cross section of the channel bracket 3 and the arcuate shape of the upper portion of the channel bracket 3, which deflects water down the sides of the bracket 3.

Further, the design of the fixture allows the light shelter 9 to be removed and replaced without any tools and without any supplementary connecting hardware. With the light shelter 9 removed, the light device 7 is accessible and a lighting element, such as a light bulb, is easily removed and replaced. The relatively large size of the open portion 15 of the light shelter 9 provides sufficient ventilation to allow a large wattage bulb to be used with the fixture.

For the foregoing reasons it is clear that the current invention provides an outdoor light fixture that protects the lighting device 7 from typical outdoor weather. The invention design allows flexibility in the selection of the light shelter 9 exterior configuration. Although the preferred embodiment of the light shelter 9 has been generally described, the light shelter 9 may be transparent, translucent or opaque, and the exterior of the shelter 9 may also have decorative designs and overlays. The light shelter 9 may have multiple alternative exterior shapes, as required for specific applications. Additionally, the bracket assembly 1 may have multiple alternative shapes and configurations.

The invention, as described, may be applied in various applications and modified in multiple ways. Such variations are not to be regarded as a departure from the spirit of the invention, and all such modifications as would be obvious to one skilled in the art are intended to be included within the scope of the following claims. Although the materials of construction are generally described, they may also include a variety of compositions consistent with the function of the invention.

1. A light fixture comprising:
a bracket assembly comprising a channel bracket adapted to extend from a wall,
a lighting device adapted to extend from said wall, and
a light shelter having a retaining lip corresponding to said channel bracket,
wherein said light shelter retaining lip engages said channel bracket so that a substantially watertight seal is created between said retaining lip and said channel bracket, said light shelter being positioned to at least partially enclose said lighting device.

2. The light fixture of claim 1 wherein, in an installed position, said lighting device is enclosed on all horizontal sides.

3. The light fixture of claim 2 wherein, in the installed position, said light shelter is open below said lighting device and closed above said lighting device.

4. The light fixture of claim 1 wherein said channel bracket has a cross-sectional “U” shape.

5. The light fixture of claim 1 wherein, in an installed position, said channel bracket has an inverted “U” shape.

6. The fixture of claim 1 wherein said channel bracket is comprised of a planar panel having a raised containment lip.

7. The light fixture of claim 1 wherein said bracket assembly further comprises a base plate, said lighting device being connected to said wall through said base plate.

8. The light fixture of claim 7 wherein said channel bracket is molded into the surface of said base plate so that said base plate and said channel bracket comprise a single unitary component.

9. The light fixture of claim 7 wherein said base plate has an upper end and a lower end, said channel bracket having a first end adjacent to said base plate lower end, said channel bracket extending from said lower end in an upward direction uninterrupted around said lighting device in an arcuate configuration and then extending downward and terminating below said lighting device, said channel bracket second end being disposed adjacent said base plate lower end.

10. The light fixture of claim 1 wherein said light shelter has an essentially hemispherical horizontal cross section, and a vertically elongated cylindrical profile.

11. The light fixture of claim 1 wherein said light shelter has one flat vertical side and three rounded vertical sides, said flat vertical side including an slot having an arcuate upper portion.

12. The light fixture of claim 1 wherein said light shelter is supported vertically solely from said light shelter resting on a corresponding arcuate portion of said channel bracket.

13. The light fixture of claim 1 wherein said light shelter is connected to said wall solely by engagement of said light shelter retaining lip with said channel bracket.

14. The light fixture of claim 1 wherein said light shelter is made from glass or plastic.

15. The light fixture of claim 1 wherein said base plate is comprised of metal.

16. The light fixture of claim 15 wherein said base plate is comprised of aluminum.

17. The light fixture of claim 1 wherein said lighting device comprises a light socket and light bulb.

18. The light fixture of claim 1 wherein said lighting device remains dry when said light fixture is subjected to rain.

19. The lighting fixture of claim 6 wherein said base plate is planar and rectangular.

20. A lighting fixture comprising:
a base plate,
a lighting device connected to said base plate,
a bracket projecting from said base plate,
said bracket comprising a “U” shaped channel,
said bracket disposed on said base plate so that said bracket partially
encircles said lighting device, and
a light shelter having a retaining lip disposed along said light shelter perimeter, said light shelter having a secure connection with said bracket to create a watertight seal between said bracket and said light shelter, said light shelter being supported solely by said bracket, said light shelter partially enclosing said lighting device.
